(19) United States
(12) Patent Application Publication
(10) Pub. No.: US 2005/0163326 A1
(43) Pub. Date: Jul. 28, 2005

(54) Diagnostic circuit for a tweeter ina loudspeaker combination

(76) Inventor: Wolfgang Heuer, Hildesheim (DE)

Correspondence Address: KENYON & KENYON, ONE BROADWAY, NEW YORK, NY, 10004, US

(21) Appl. No.: 10/501,288

(22) PCT Filed: Jan. 16, 2003
(86) PCT No.: PCT/DE03/00105

(30) Foreign Application Priority Data
Jan. 17, 2002 (DE) 102 01 517.1

(51) Int. Cl. H04R 29/00; H04R 3/00

(52) U.S. Cl. 381/59; 381/96

(57) ABSTRACT

A diagnostic circuit for a treble loudspeaker of a loudspeaker combination of a low-frequency output stage, and a method for diagnosing the functionality of the treble loudspeaker. In order to determine the functionality of the treble loudspeaker with relatively little complexity and high reliability, a diagnostic circuit is provided that comprises an HF signal-generating device for outputting an HF voltage signal, at least one terminal for a loudspeaker combination, a measuring resistor that, upon connection of the loudspeaker combination to the terminal, forms therewith a voltage divider circuit, and a measurement device for measuring a complex measured voltage dropping in the voltage divider circuit and for ascertaining a condition of the treble loudspeaker of the loudspeaker combination.

### FIELD OF THE INVENTION

The present invention relates to a diagnostic circuit for a treble loudspeaker of a loudspeaker combination, as well as a method for testing a treble loudspeaker of a loudspeaker combination.

### BACKGROUND INFORMATION

In low-frequency output stages of loudspeaker systems that are provided, for example, in a motor vehicle, a bass and a midtone loudspeaker, or a midtone/bass loudspeaker, are generally connected directly to the amplifiers of the low-frequency output stages, and a treble loudspeaker is coupled capacitatively. The functionality of this loudspeaker combination is tested in particular upon installation into a vehicle, and as applicable at maintenance intervals or in the event of malfunctions. Interruptions or short circuits in the supply leads may, in particular, occur in this context. Testing of the bass, midtone, or midtone/bass loudspeakers can be accomplished directly in resistive fashion using an applied DC voltage. A corresponding testing of the capacitatively connected treble loudspeaker is, however, not thereby possible. This testing is accordingly usually performed by input of a treble signal and acoustic perception. Such testing is, however, time-consuming and imprecise in the context of automated production.

Also conventional are circuit assemblages in which the current consumption of an output stage 1C is measured upon application of a high LF frequency and a high output level. For this purpose, a measurement device must be appropriately provided in the power supply to the power output stages.

### SUMMARY

A diagnostic circuit and method according to example embodiments of the present invention as may have, in contrast, the particular advantage that an accurate measurement of the functionality of a treble loudspeaker of a loudspeaker combination is possible with relatively little complexity.

According to the present invention, testing of the treble loudspeaker is thus made possible by the fact that a voltage divider circuit is constituted from a preferably purely ohmic resistor and the loudspeaker combination, and a voltage drop within that voltage divider circuit is measured and evaluated. In particular, the voltage drop can be measured in this context as a complex measured voltage at the loudspeaker combination; in principle, however, a measurement of the voltage drop at the measuring resistor is also possible.

In the voltage divider circuit, the bass, midtone, or midtone/bass loudspeaker or loudspeakers are connected in parallel with the coupling capacitor and the treble loudspeaker. The functionality or condition of the treble loudspeaker affects the complex total resistance of the loudspeaker combination at the HF frequency. An interruption at the treble loudspeaker or its supply leads results in an increase in the total resistance, and a short circuit correspondingly in a decrease in the total resistance, as compared with the total resistance when the treble loudspeaker is functional. Since the loudspeakers designed for lower frequencies have a higher inductance than the treble loudspeaker, they have little influence on the measured signal.

The measured complex measured voltage can be evaluated, for example, by measuring the peak value phase-shifted with respect to the output signal, or by way of a rectifier circuit.

### BRIEF DESCRIPTION OF THE DRAWINGS

The present invention is explained below, in connection with several embodiments, with reference to the figures.

FIG. 1 is a block diagram of a power output stage having a diagnostic circuit according to a first embodiment of the present invention.

FIG. 2 is a block diagram of a power output stage having a diagnostic circuit according to a second embodiment of the present invention.

### DETAILED DESCRIPTION OF EXAMPLE EMBODIMENTS

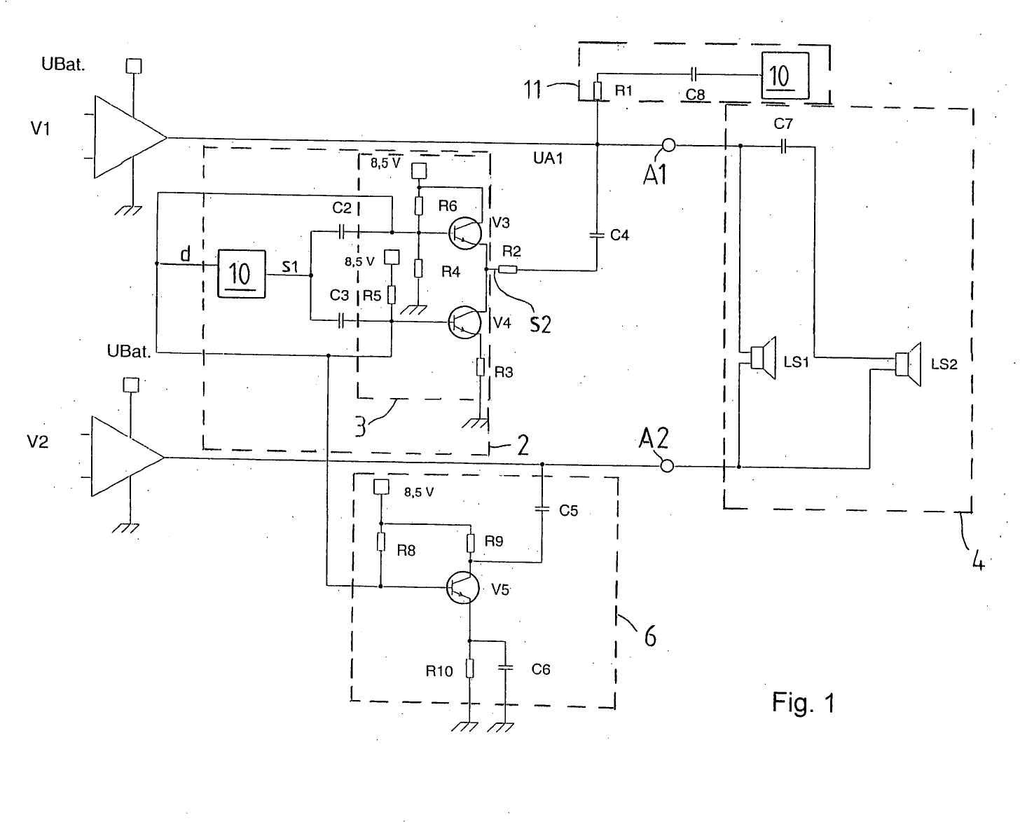

As shown in FIG. 1, a first output amplifier V1 of a low-frequency output stage is connected via a first terminal A1 to the positive pole on loudspeaker combination 4, and a second output amplifier V2 of the low-frequency output stage is connected via a second terminal A2 to the negative pole of loudspeaker combination 4. Loudspeaker combination 4 has a midtone/bass loudspeaker LS1 that is connected to terminals A1, A2, and a treble loudspeaker LS2 connected via a capacitor C7 in parallel with LS1. For diagnosis of treble loudspeaker LS2, loudspeakers LS1 and LS2 are activated and amplifiers V1, V2 are switched off and are thus high-resistance. A processor 10 outputs an HF input signal s1 that is outputted via an impedance converter 3 as HF voltage signal s2. Processor 10 thus constitutes, with impedance converter 3, an HF voltage-generating device 2. HF input signal s1 is transferred through a resistor R2 and a capacitor C4 to first terminal A1, i.e., to the positive pole of loudspeaker combination 4. Second terminal A2 is grounded through a connecting device 6. At A1, the voltage drop at loudspeaker combination 4 and at connecting device 6 is picked off by a measurement device 11 as complex measured voltage UA1.

In HF voltage-generating device 2, HF input signal s1 having a frequency greater than or equal to 20 KHz, and a diagnostic signal d constituting a DC voltage signal, are output by processor 10. Diagnostic signal d sets a diagnostic mode. Processor 10 also (in a manner not shown) switches output amplifiers V1, V2 to high resistance by way of diagnostic signal d. HF voltage signal s is conveyed through a capacitor C2, together with diagnostic signal d, to an emitter follower transistor V3 of impedance converter 3, the working point of the base of emitter follower transistor V3 being set by way of resistors R4, R6. A further transistor V4 and a resistor R3 constitute a constant-current source connected to the emitter of V3, V4 being made conductive upon application of diagnostic signal d to its base. Impedance converter 3 outputs an HF voltage signal S2 that drops to ground through measuring resistor R2, capacitor C4, loudspeaker combination 4, and connecting device 6.

Connecting device 6 has a transistor V5 that is modulated by diagnostic signal d and connects an AC voltage present at second terminal A2 to ground in low-resistance fashion. With suitable dimensioning of capacitors C4, C7, HF voltage signal S2 thus drops substantially at a series circuit of R2 and the parallel-connected loudspeakers LS1 and LS2.

Measured voltage UA1 present at A1 is received by a measurement device 11 that is constituted by a resistor R1, a capacitor C8, and processor 10 that serves as the evaluation device. Measured voltage UA1 is phase-shifted with respect to S1, in particular because of the impedances of LS1 and LS2. In the example embodiment shown in FIG. 1, the phase-shifted peak value is determined by measurement device 11, and because R2 is known, the impedance of loudspeaker combination 4 is ascertained therefrom. Since LS1 has a high inductance, the voltage drop between A1 and A2 is determined substantially by LS2. Measurement device 11 thus identifies a low measured voltage (or a measured voltage with a low absolute value) in the event of a short circuit, a high measured voltage in the event of an interruption at LS2, and a moderate measured voltage when LS2 is in the functional condition.

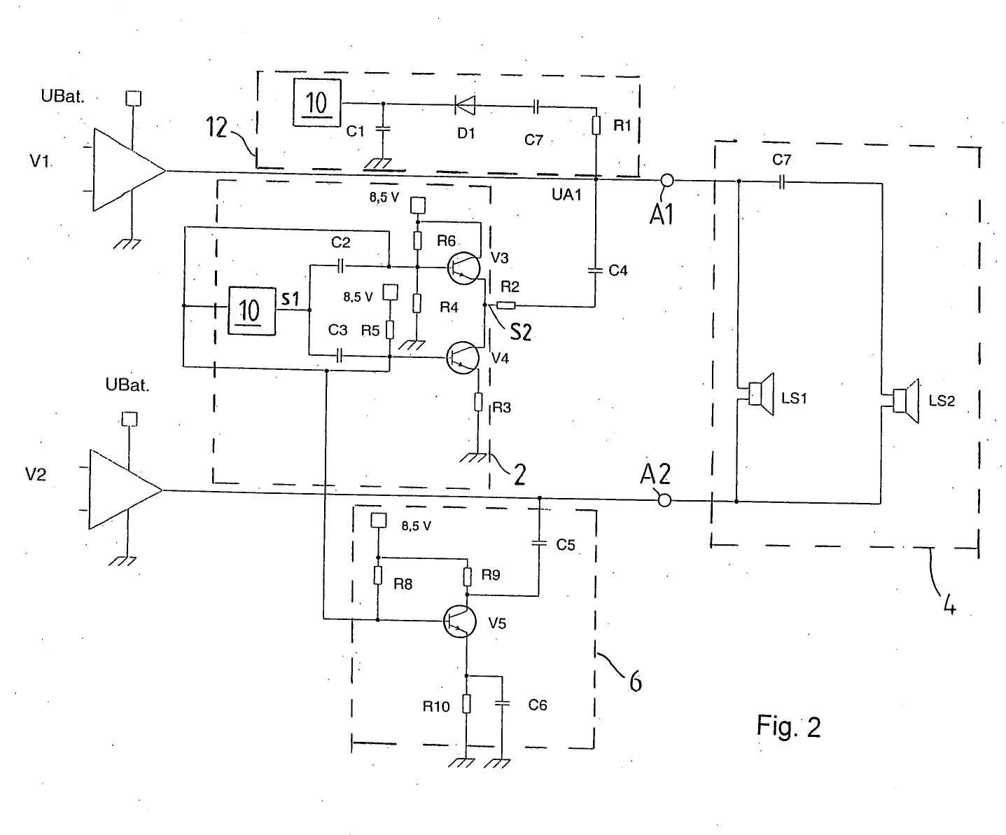

In the example embodiment shown in FIG. 2, unlike in the first example embodiment, a measurement device 12 is used in which a resistor R1, capacitor C7, a Schottky diode D1, and a grounded capacitor C1 serve to rectify the received AC voltage signal, so that processor 10 can receive a rectified voltage.

1-17. (canceled)

18. A diagnostic circuit for a treble loudspeaker of a loudspeaker combination, the diagnostic circuit, comprising:
a high frequency (HF) signal-generating device configured to output an HF voltage signal;
at least one terminal for the loudspeaker combination;
a measuring resistor that, upon connection of the loudspeaker combination to the terminal, forms therewith a voltage divider circuit; and
a measurement device configured to measure a complex measured voltage drop in the voltage divider circuit and to ascertain a condition of the treble loudspeaker of the loudspeaker combination.

19. The diagnostic circuit as recited in claim 18, wherein the measuring resistor is between the HF signal-generating device and the terminal, and the measurement device measure a measured voltage drop substantially at the loudspeaker combination.

20. The diagnostic circuit as recited in claim 19, further comprising:
a capacitor connected between the measuring resistor and the terminal.

21. The diagnostic circuit as recited in claim 18, wherein the HF signal-generating device includes an HF signal source configured to output an HF input signal, and a downstream impedance converter that is configured to be switched on by a DC voltage diagnostic signal.

22. The diagnostic circuit as recited in claim 21, wherein the impedance converter includes an emitter follower transistor that is configured to receive the HF input signal and the diagnostic signal.

23. The diagnostic circuit as recited in claim 22, wherein a current source which includes a second transistor configured to be switched on by the diagnostic signal is an emitter resistor of the emitter follower transistor, a collector of the second transistor is connected to an emitter of the emitter follower transistor, an emitter of the second transistor is grounded through a resistor, and a base of the second transistor is configured to be activated by the diagnostic signal.

24. The diagnostic circuit as recited in claim 23, wherein the base of the second transistor is configured to be activated by the HF input signal.

25. The diagnostic circuit as recited in claim 18, wherein the measurement device is configured to ascertain a peak value of the measured voltage.

26. The diagnostic circuit as recited in claim 24, wherein the measurement device includes a resistor connected to the terminal device, a capacitor connected to the resistor, and an evaluation device.

27. The diagnostic circuit as recited in claim 18, wherein the measurement device includes a rectifier circuit configured to rectify the measured voltage and output a rectified measured voltage signal to an evaluation device.

28. The diagnostic circuit as recited in claim 26, wherein the rectifier circuit includes a series circuit including a resistor, a capacitor, and a Schottky diode, the series circuit being grounded through a second capacitor.

29. The diagnostic circuit as recited in claim 18, wherein the measurement device is configured to deduce a short circuit of the treble loudspeaker when a low measured voltage is ascertained, a correct condition of the treble loudspeaker from a moderate measured voltage, and an interruption at the treble loudspeaker from a high measured voltage.

30. The diagnostic circuit as recited in claim 18, wherein the measuring resistor is a purely ohmic resistor.

31. A method for testing a treble loudspeaker of a loudspeaker combination, comprising:
outputting a high frequency (HF) voltage signal to a voltage divider circuit made up of a measuring resistor and the loudspeaker combination;
measuring a complex measured voltage drop in the voltage divider; and
deducing a condition of the treble loudspeaker from the measured voltage.

32. The method as recited in claim 31, wherein the measured voltage is measured as a voltage drop at the loudspeaker combination.

33. The method as recited in claim 31, wherein a short circuit at the treble loudspeaker is deduced when a low measured voltage is ascertained at the loudspeaker combination, a correct condition of the treble loudspeaker is deduced when a moderate measured voltage is ascertained at the loudspeaker combination, and an interruption at the treble loudspeaker is deduced when a high measured voltage is ascertained at the loudspeaker combination.

34. The method as recited in claim 30, wherein a peak value of the complex measured voltage is measured and subsequently evaluated.

35. The method as recited in claim 31, wherein the complex measured voltage is rectified and subsequently evaluated.
